(19) United States
(12) Patent Application Publication
(10) Pub. No.: US 2008/0253858 A1
(43) Pub. Date: Oct. 16, 2008

(54) Screwing device with function of twisting force measurement

(76) Inventor: Chih-Ching Hsieh, Taichung City (TW)

Correspondence Address: Chih-Ching Hsieh, 235 Chung - Ho, Box 8-24, Taipei, TW

(21) Appl. No.: 11/786,349

(22) Filed: Apr. 12, 2007

(51) Int. Cl. F16B 31/02

(52) U.S. Cl. 411/14

(57) ABSTRACT

A screwing device with a function of twisting force measurement comprises: a screw unit having a head and a shank connected to the head; a twisting force measurement unit installed at the head and having a processor and displaying unit and a sensor for measuring a twisting force applied to the screw unit; the processor and displaying unit serving for calculating a value of the twisting force from the sensor and having a display screen. The sensor is installed at a lateral side of the head. The processor and displaying unit is installed at or is capable of being plug-in to a top of the head. Or the head has a recess at a top thereof and the sensor is installed at a lateral side of the recess; and the processor and displaying unit installed at or is capable of being plug-in to a lateral side of the head.

### FIELD OF THE INVENTION

The present invention relates to screw devices, and in particular to a screwing device with a function of twisting force measurement, wherein the twisting force applied to the screw unit is measured directly so as to improve the defect in the prior art.

### BACKGROUND OF THE INVENTION

In screwing a screw unit, an extreme allowable torque is confined for the screw unit. If the twisting force applied to the screw unit is over the extreme allowable torque, the screw unit will break or crack, this will affect the quality of the work. If the screw unit cracks in the object to be locked, while the worker do not find, this will induce some dangers in the object as it works for a long time. Thus there is a necessity for knowing the twisting force applied to the screw unit. In many applications, the spanners for driving the screw units are installed with strain gauges for measuring the twisting forces applied thereto. However, these tools only measure the twisting forces applied to the spanners instead of the twisting forces applied to the screw units. If the twisting force is greater, the errors between the twisting force applied to the spanner and the twisting force applied to the screw unit will become large. Thus it is possible that some accidents are induced, especially if the objects to be screwed are cylinders, casings of boats or planes, etc, it will induce a great accident and a great trouble.

### SUMMARY OF THE INVENTION

Accordingly, the primary object of the present invention is to provide a screwing device with a function of twisting force measurement, wherein the twisting force applied to the screw unit is measured directly so as to improve the defect in the prior art.

To achieve above objects, the present invention provides a screwing device with a function of twisting force measurement comprising: a screw unit having a head and a shank connected to a lower side of the head; a twisting force measurement unit installed at the head and having a processor and displaying unit and a sensor; the sensor serving for measuring a twisting force applied to the screw unit; the processor and displaying unit serving for calculating a value of the twisting force transferred from the sensor and having a screen for displaying the value of the twisting force. The sensor is installed at a lateral side of the head. The processor and displaying unit is installed at or is capable of being plug-in to a top of the head. Or the head has a recess at a top thereof and the sensor is installed at a lateral side of the recess of the head; and the processor and displaying unit installed at or is capable of being plug-in to a lateral side of the head.

The various objects and advantages of the present invention will be more readily understood from the following detailed description when read in conjunction with the appended drawing.

### BRIEF DESCRIPTION OF THE DRAWINGS

FIG. 1 is a perspective view showing the first embodiment about the screwing device with a function of twisting force measurement of the present invention.

FIG. 2 is a perspective view showing the second embodiment about the screwing device with a function of twisting force measurement of the present invention.

FIG. 3 is a perspective view showing the third embodiment of the screwing device with a function of twisting force measurement of the present invention.

FIG. 4 is a perspective view showing the fourth embodiment of the screwing device with a function of twisting force measurement of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

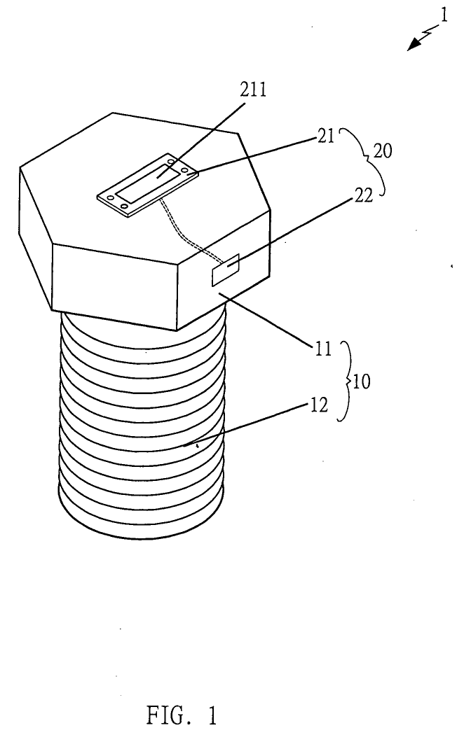

Referring to FIG. 1, the screwing device 1 with a function of twisting force measurement of the present invention is illustrated. The present invention has the following elements.

A screw unit 10 has a head 11 and a shank 12 connected to a lower side of the head 11. In this the present invention, the head 11 has a hexagonal shape.

A twisting force measurement unit 20 has a processor and displaying unit 21 and a sensor 22. The processor and displaying unit 21 is installed at a top of the head 11 and the sensor 22 is installed at a lateral side of the head 11. The sensor 22 is one of a strain gauge and a piezoelectric measurement switch. The processor and displaying unit 21 has a screen 211 for displaying a value of a twisting force transferred from the sensor 22.

In driving the screw unit 10 of the present invention, the sensor 22 will measure the twisting force applied to the screw unit 10 and then the measurement signal is transferred to the processor and displaying unit 21 and the processor and displaying unit 2 will calculate the value of the twisting force which is then is displayed on the screen 211. In the present invention, the twisting force measurement unit 20 is directly installed on the screw unit 10 so that the twisting force can be sensed effectively. Thus, the worker can lock the screw units 10 with sufficient number and forces, for example, locking the screw units 10 to a cylinder of a car, a casing of a boat or a plane. Because the sufficient number of screw units 10 are locked to these bodies with proper locking force, these objects will have concrete structures without breaking or cracking or falling out.

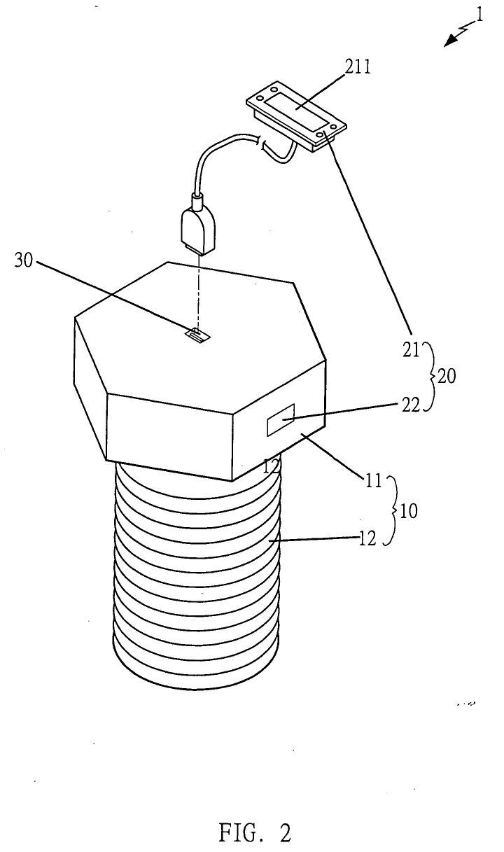

With reference to FIG. 2, another embodiment of the present invention is illustrated. In this embodiment, those identical to the above mentioned embodiment will not be further described herein. Only those difference are disclosed. In this the present invention, an upper side of the head 11 has a slot 30 for receiving the processor and displaying unit 21 of the twisting force measurement unit 20. Thus, the cost is low because one processor and displaying unit 21 is used to various screw units 10.

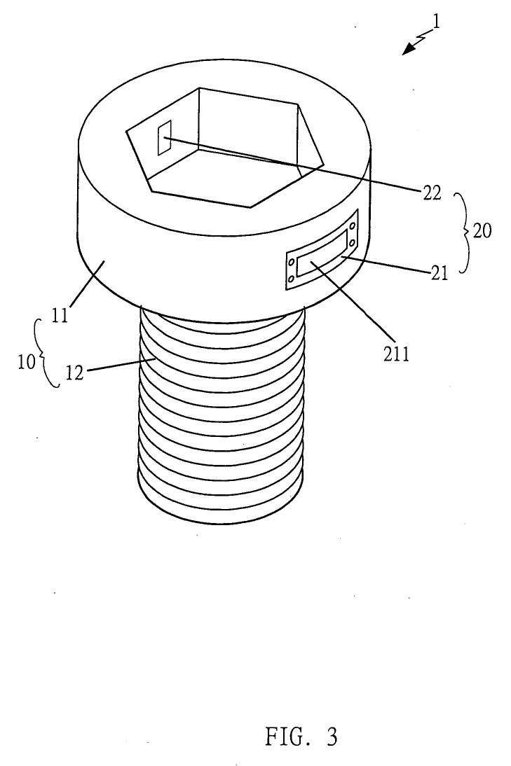

With reference to FIG. 3, it is illustrated that the present invention is applied to an inner hexagonal screw unit. In this embodiment, those identical to the above mentioned embodiment will be given the same numbers as those in above mentioned embodiments.

A screw unit 10 has a head 11 and a shank 12 connected to a lower side of the head 11. In this the present invention, the head 11 has a hexagonal recess at a top end thereof.

A twisting force measurement unit 20 has a processor and displaying unit 21 and a sensor 22. The processor and displaying unit 21 is installed at a lateral side of the head 11 and the sensor 22 is installed at a lateral side of the hexagonal recess of the head 11. The sensor 22 is one of a strain gauge and a piezoelectric measurement switch. The processor and displaying unit 21 has a screen 211 for displaying a value of a twisting force transferred from the sensor 22.

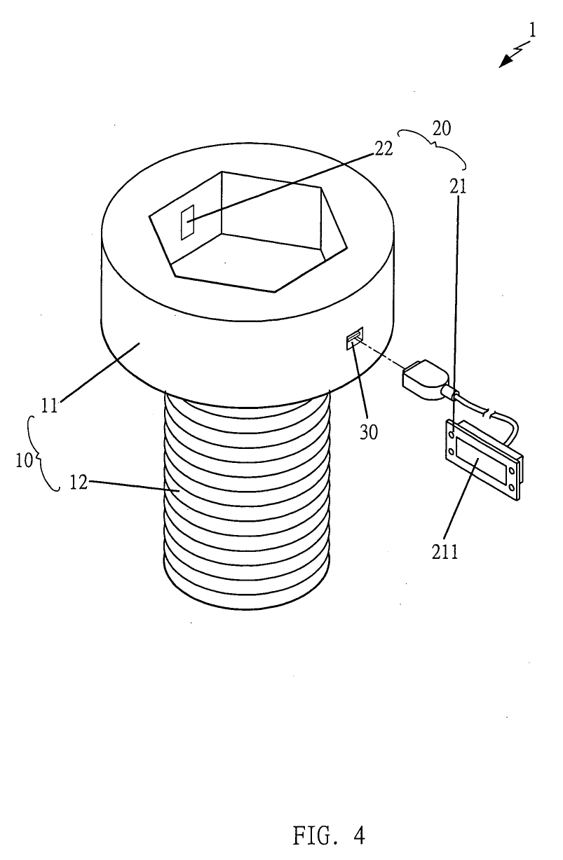

With reference to FIG. 4, it is illustrated that the present invention is applied to an inner hexagonal screw unit. In this embodiment, those identical to the above FIG. 3 will be given the same numbers as those in above mentioned embodiments. In this embodiment, the lateral side of the head 11 has a slot 30 for receiving the processor and displaying unit 21. Thus, the cost is low with one processor and displaying unit 21 is used to various screw units 10.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A screwing device with a function of twisting force measurement comprising:
a screw unit having a head and a shank connected to a lower side of the head;
a twisting force measurement unit installed at the head and having a processor and displaying unit and a sensor; the sensor serving for measuring a twisting force applied to the screw unit; the processor and displaying unit serving for calculating a value of the twisting force transferred from the sensor and having a screen for displaying the value of the twisting force.

2. The screwing device with a function of twisting force measurement as claimed in claim 1, wherein the sensor is installed at a lateral side of the head.

3. The screwing device with a function of twisting force measurement as claimed in claim 2, wherein the processor and displaying unit is installed at a top of the head.

4. The screwing device with a function of twisting force measurement as claimed in claim 3, wherein the sensor is one of a strain gauge and a piezoelectric measurement switch.

5. The screwing device with a function of twisting force measurement as claimed in claim 4, wherein the head has a hexagonal shape.

6. The screwing device with a function of twisting force measurement as claimed in claim 2, wherein the processor and displaying unit is capable of being plugged to a top of the head for receiving the signals of the twisting force from the sensor.

7. The screwing device with a function of twisting force measurement as claimed in claim 6, wherein the sensor is one of a strain gauge and a piezoelectric measurement switch.

8. The screwing device with a function of twisting force measurement as claimed in claim 7, wherein the head has a hexagonal shape.

9. The screwing device with a function of twisting force measurement as claimed in claim 1, wherein the head has a recess at a top thereof and the sensor is installed at a lateral side of the recess of the head.

10. The screwing device with a function of twisting force measurement as claimed in claim 9, wherein the processor and displaying unit is installed at a lateral side of the head.

11. The screwing device with a function of twisting force measurement as claimed in claim 10, wherein the sensor is one of a strain gauge and a piezoelectric measurement switch.

12. The screwing device with a function of twisting force measurement as claimed in claim 11, wherein the recess has a hexagonal shape.

13. The screwing device with a function of twisting force measurement as claimed in claim 9, wherein the processor and displaying unit is capable of being plugged to a lateral side of the head for receiving the signals of the twisting force from the sensor.

14. The screwing device with a function of twisting force measurement as claimed in claim 13, wherein the sensor is one of a strain gauge and a piezoelectric measurement switch.

15. The screwing device with a function of twisting force measurement as claimed in claim 14, wherein the recess of the head has a hexagonal shape.
